(19) United States
(12) Patent Application Publication
(10) Pub. No.: US 2009/0228641 A1
(43) Pub. Date: Sep. 10, 2009

(54) INFORMATION PROCESSING APPARATUS AND NON-VOLATILE SEMICONDUCTOR MEMORY DRIVE

(75) Inventor: Takehiko Kurashige, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/391,135

(22) Filed: Feb. 23, 2009

Related U.S. Application Data
(63) Continuation of application No. PCT/JP2008/071174, filed on Nov. 14, 2008.

(30) Foreign Application Priority Data
Mar. 7, 2008 (JP) 2008-058543

(51) Int. Cl. G06F 12/02; G06F 12/00

(52) U.S. Cl. 711/103; 711/154; 711/E12.001; 711/E12.008

(57) ABSTRACT

According to one embodiment, an information processing apparatus includes a main body and a memory drive which is accommodated in the main body. The main body includes a reload module which recovers a storage state at a predetermined time point of the memory drive into the memory drive, and a forcibly reset module which reactivates the memory drive in a state of storing the storage state recovered by the reload module. The memory drive includes the non-volatile semiconductor memory which includes a plurality of storage areas where information is writable and information is readable, and a memory control module which writes the storage state at the predetermined time point input from the main body into the non-volatile semiconductor memory, and reactivates the memory drive in a state where the written storage state is stored in the non-volatile semiconductor memory.

### CROSS REFERENCE TO RELATED APPLICATIONS

This is a Continuation Application of PCT Application No. PCT/JP2008/071174, filed Nov. 14, 2008, which was published under PCT Article 21(2) in English.

This application is based upon and claims the benefit of priority from Japanese Patent Application No. 2008-058543, filed Mar. 7, 2008, the entire contents of which are incorporated herein by reference.

### BACKGROUND

1. Field

One embodiment of the invention relates to an information processing apparatus and a non-volatile semiconductor memory drive.

2. Description of the Related Art

As regards a conventional technique, a computer system which efficiently obtains snapshot content of a program or data at a prescribed time point without impairing existing environment has been widely known (e.g., Jpn. Pat. Appln. KOKAT Publication No. 11-120055). The snapshot means a copy image of a file, disk, etc., at a certain time point, and is generated by periodically copying the entire of the file and the disk to the same disk storage device or another disk storage device.

According to this computer system, even if the program or data has been lost due to any problem, loading the stored snapshot into a new disk storage device enables recovering the program or data when the snapshot has been obtained.

Although a life time or a disk damage of a hard disk drive (HDD) which has been widely used causes a loss of a program or data of the disk storage device, in recent years, a non-volatile semiconductor storage device consisting of a non-volatile semiconductor memory such as a NAND memory not having any mechanical drive part has become widely known.

Meanwhile, in the non-volatile semiconductor storage device, firmware stores a current state in re-booting. Therefore, to prepare a debug environment, if reloads the snapshot to the non-volatile semiconductor device and reboots the nonvolatile semiconductor device, the storage of the current state by the firmware causes a contradiction between the snapshot and the reloaded data.

The present invention has been made in consideration of the above, and an object of the present invention is to provide an information processing apparatus and a non-volatile semiconductor memory drive which can surely reproduce a state of an occurrence of a problem in manufacturing, developing and in diagnosing a failure.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a schematic configuration of the information processing apparatus according to embodiment;

FIG. 3 is an exemplary block diagram showing a schematic configuration of a solid-sate drive (SSD) according to the embodiment;

FIG. 4 is an exemplary schematic view showing storage capacities and storage areas of the SSD according to the embodiment;

FIG. 5 is an exemplary schematic view of a NAND memory according to the embodiment;

FIG. 6 is an exemplary flowchart showing a first operation of the information processing apparatus according to the embodiment; and

FIG. 7 is an exemplary flowchart showing a second operation of the information processing apparatus according to the embodiment.

### DETAILED DESCRIPTION

Various embodiments according to the invention will be described hereinafter with reference to the accompanying drawings. In general, according to one embodiment of the invention, an information processing apparatus includes an information processing apparatus main body, and a non-volatile semiconductor memory drive which is accommodated in the information processing apparatus main body. The information processing apparatus main body includes a reload module which recovers a storage state at a predetermined time point of the non-volatile semiconductor memory drive into the non-volatile semiconductor memory drive, and a forcibly reset module which reactivates the non-volatile semiconductor memory drive in a state of storing the storage state recovered by the reload module. The non-volatile semiconductor memory drive includes the non-volatile semiconductor memory which includes a plurality of storage areas where information is writable and information is readable, and a memory control module which writes the storage state at the predetermined time point input from the information processing apparatus main body into the non-volatile semiconductor memory, and reactivates the non-volatile semiconductor memory drive in a state where the written storage state is stored in the non-volatile semiconductor memory.

### (Configuration of Information Processing Apparatus)

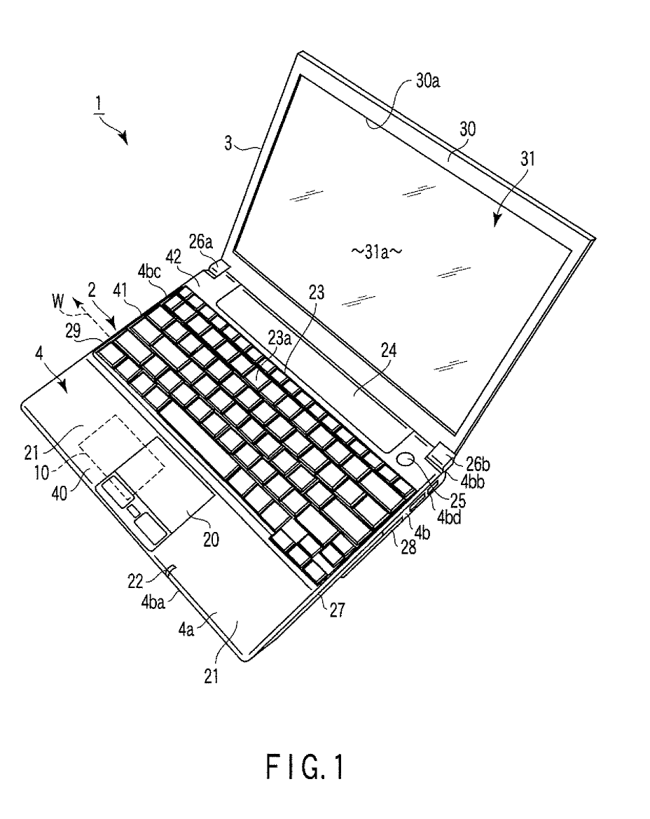

FIG. 1 is an exemplary perspective view showing an external appearance of an information processing apparatus 1 according to an embodiment of the invention. The information processing apparatus 1 is composed of a main body 2, and a display unit 3 attached to the main body 2, as shown in FIG. 1.

The main body 2 has a box-shape housing 4, and the housing 4 includes a top wall 4a, a peripheral wall 4b and a bottom wall (not shown). The top wall 4a of the housing 4 includes a front part 40, a central part 41 and a back part 42 which are arranged in order from a side close to a user who operates the information processing apparatus 1. The bottom wall is positioned opposite side of the top wall 4a, and faces an installation surface on which the information processing apparatus 1 is placed. The peripheral wall 4b includes a front wall 4ba, a rear wall 4bb, and right and left sidewalls 4bc, 4bd.

The front part 40 includes a touch pad 20 which is a pointing device, a palm rest 21, and a liquid crystal display (LCD) 22 which illuminates in conjunction with an operation of each of the components of the information processing apparatus 1.

The central part 41 includes a keyboard mounting part 23 on which a keyboard 23a capable of inputting character information, etc., is mounted.

The back part 42 includes a battery pack 24 which is detachably attached, a power switch 25 for turning on the power of the information processing apparatus 1 on the right side of the battery pack 24, and a pair of hinge units 26a, 26b which rotatably supports the display unit 3 at the right and left sides of the battery pack 24.

An exhaust port 29 (not shown) for exhausting wind “W”from inside of the housing 4 to the outside thereof is disposed on the left sidewall 4bc of the housing 4. An optical disc drive (ODD) 27 capable of reading and writing data from and to an optical storage medium such as a DVD, and a card slot 28 infor putting in and taking out various cards are arranged

The housing 4 is formed of a housing cover including a part of the peripheral wall 4b and the top wall 4a, and a housing base including a part of the peripheral wall 4b and the bottom wall. The housing cover is detachably coupled to the housing base to form a housing space along with the housing base. The housing space houses a solid-state drive (SSD) 10, etc., as a nonvolatile semiconductor memory drive. Details of the SSD 10 will be described later.

The display unit 3 includes a display housing 30 including an opening 30a, and a display device 31 composed of an LCD, etc., capable of displaying images on a display 31a. The display unit 31 is housed in the display housing 30, and the display 31a is exposed to the outside of the display housing 30 through the opening 30a.

In the housing 4, a main circuit board, an expansion module, a fan, etc., not shown, are housed, as well as the SSD 10, the battery pack 24, the ODD 27 and the card slot 28.

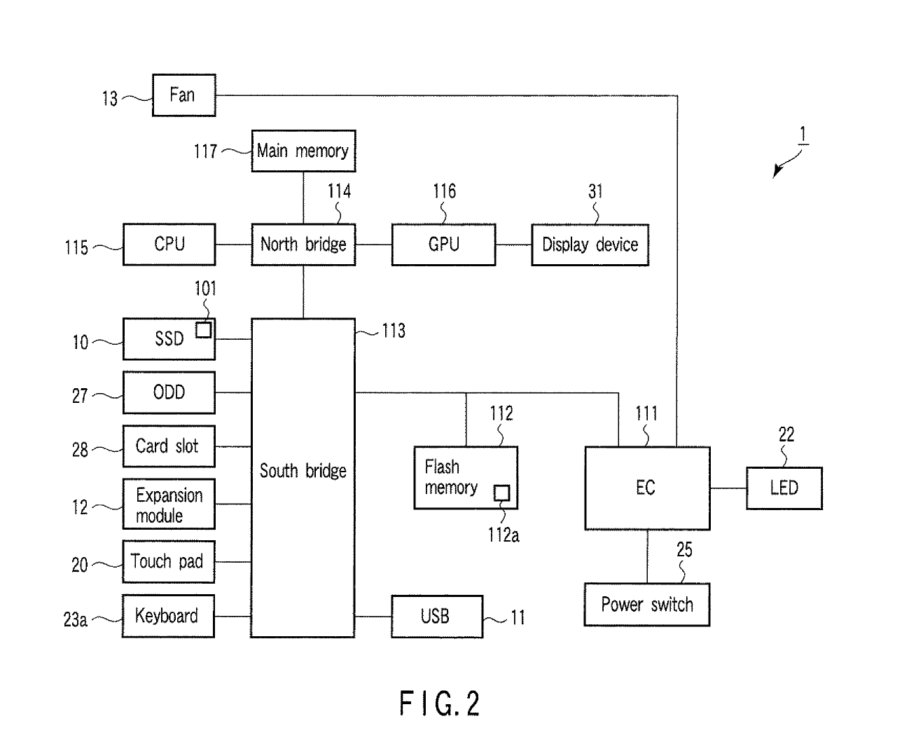

FIG. 2 is an exemplary block diagram showing a schematic configuration of the information processing apparatus 1 according to the embodiment of the invention.

The information processing apparatus 1 includes, as shown in FIG. 2, an embedded controller (EC) 111 which is an embedded system for controlling each component, a flash memory 112 which stores a basic input/output system (BIOS) 112a, a south bridge 113 which is a large scale integration (LST) chip and functions as various bus controllers and as an I/O controller, a north bridge 114, which is an LSI chip, for controlling connections among a central processing unit (CPU) 115 to be described below, a graphic processing unit (GPU) 116, a main memory 117 and various buses, a CPU 115 as a main control unit for computing various signals, a GPU 116 which controls and computes a video signals for display, and a main memory 117 read and written by the CPU 115, as well as the SSD 10, the expansion module 12, the fan 13, the touch pad 20, the LCD 22, the keyboard 23a, the power switch 25, the ODD 27, the card slot 28 and the display device 31.

The expansion module 12 includes an expansion circuit board, a card socket mounted on the expansion circuit board, and an expansion module board inserted in the card socket. The card socket is based on the standards of Mini-PCI, etc., and the expansion module board may be a third generation (3G) module, a television tuner, a GSP module and a Wimax (trade mark) module.

The fan 13 is a cooling unit which cools the Inside of the housing 4 by means of ventilation, and exhausts the air in the housing 4 to the outside as wind “W” via the exhaust port 29 (not shown).

The EC 111, the flush memory 112, the south bridge 113, the north bridge 114, the CPU 115, the GPU 116 and the main memory 117 are electronic components mounted on the main circuit board.

### (Configuration of SSD)

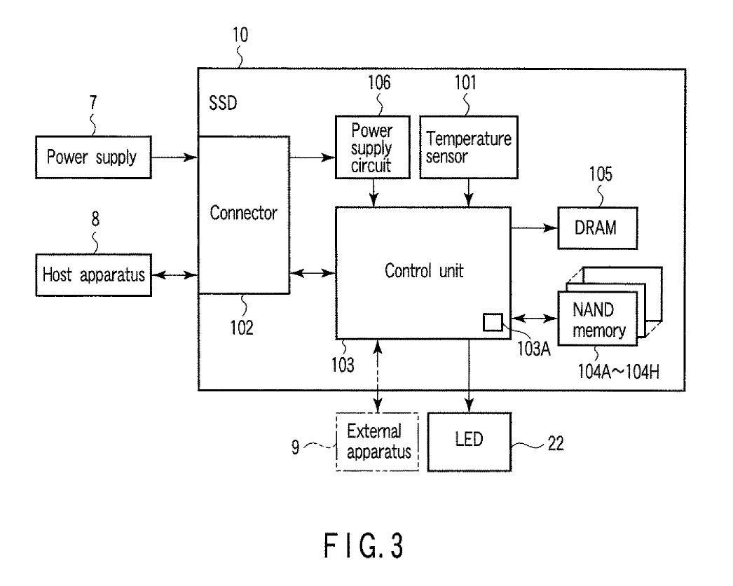

FIG. 3 is an exemplary block diagram showing a schematic configuration of the SSD 10 according to the embodiment of the invention. The SSD 10 is schematically formed of a temperature sensor 101, a connector 102, a control unit 103, NAND memories 104A-104H, a DRAM 105, and a power supply circuit 106, as is shown in FIG. 3. The SSD 10 is an external storage device which stores data and programs and from which records are not lost even if the power is not supplied thereto. Although the SSD 10 has no drive mechanism such as a magnetic disk or a head like a conventional hard disk drive, the SSD 10 stores program such as an operating system (OS), data generated by a user or executing software, etc., readably and secularly in the storage areas of the NAND memories in the same way as that of the hard disk drive, and is a drive composed of a non-volatile semiconductor memory capable of operating as an boot drive of the information processing apparatus 1.

The control unit 103 as a memory controller is connected to each of the connector 102, the eight NAND memories 104A-104H, the DRAM 105 and the power supply circuit 106.

The control unit 103 is connected to a host apparatus 8 via the connector 102, and is connected to the external apparatus 9, as necessary. Further, the control unit 103 is provided with an environment storage recovering module 103A which reads to exteriorly store the storage states of the NAND memories 104A-104H and also writes again the storage states of the NAND memories 104A-104H externally stored to recover the storage states.

A power supply 7 is a battery pack 24 or an AC adapter, not shown, and DC 3.3V DC is supplied to the power supply circuit 106 via the connector 102, for example. Further, the power supply 7 supplies power to the entirety of the information processing apparatus 1.

The host apparatus 8 is a main circuit board, in this embodiment, and the south bridge 113 mounted on the main circuit board is connected to the control unit 103. Data transmission is made between the south bridge 113 and the control unit 103 based on the standard of a serial ATA, for example.

The external apparatus 9 is an information processing apparatus differing from the information processing apparatus 1. With respect to the SSD 10 detached from the information processing apparatus 1, the external apparatus 9 is connected to the control unit 103 based on standard of an RS-232c, for example, and has a function of reading data stored in the NAND memories 104A-104H.

The board on which the SSD 10 is mounted has, for example, the same outer shape and size as that of a hard disk drive (HDD) of a 1.8-inch type or a 2.5-inch type. In this embodiment, the outer shape and size is the same as that of the 1.8-inch type.

The control unit 103 controls operations of the NAND memories 104A-104H. More specifically, the control unit 103 controls reading/writing of data from/to the NAND memories 104A-104H in response to a request from the host apparatus 8. The data-transmission speed is 100 MB/sec in data reading and 40 MB/sec in data writing, for example.

Each of the NAND memories 104A-104H is, for example, a non-volatile semiconductor memory with 16 GB as a storage capacity, and is, for example, a multi level cell (MLC)-NAND memory (multi-value NAND memory) capable of 2-bit recording in one memory cell. The MLC-NAND memory generally has no advantage over rewritable times as compared with a single level cell (SLC)-NAND memory, but the storage capacity can be easily increased.

The DRAM 105 is a buffer in which the data is temporarily stored at the time of data reading/writing from/to the NAND memories 104A-104H according to control of the control unit 103.

The connector 102 has a shape based on the standards such as a Serial ATA. The control unit 103 and the power supply circuit 106 may be connected to the host apparatus 8 and the power supply 7, respectively, via different connectors.

The power supply circuit 106 converts 3.3V DC supplied from the power supply 7 to 1.8V, 1.2V DC, for example, and supplies the three kinds of voltages to each component according to the drive voltage of each component of the SSD 10.

(Storage Capacity of SSD)

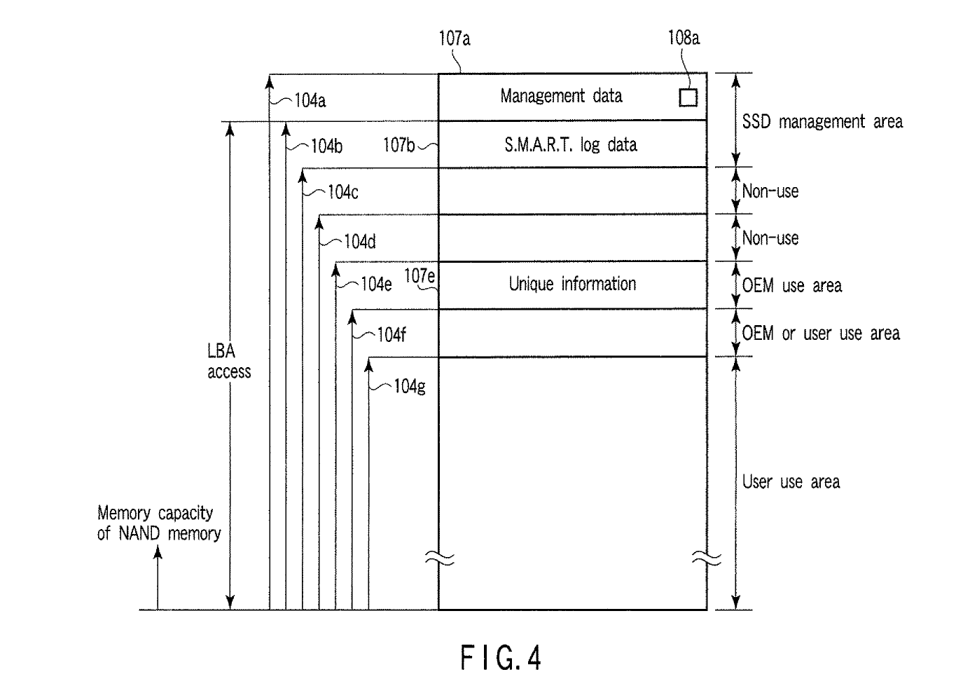

FIG. 4 schematically shows storage capacities and storage areas of the SSD 10 according to the embodiment of the invention. The storage capacity of the SSD 10 is formed of storage capacities 104a-104g as shown in FIG. 4.

The storage capacity 104a is a NAND Capacity, i.e., the maximum storage capacity using the storage areas of all the NAND memories 104A-104H. For instance, when the storage capacities of each of the NAND memories 104A-104H is 16 GB, the storage capacity 104a is 128 GB. The storage capacity 104a is given by NAND configuration information of a manufacturing information writing command of a universal asynchronous receiver-transmitter (UART).

The storage capacity 104b is a Max Logical Capacity, and is the maximum storage capacity accessible by logical block addressing (LBA).

The storage capacity 104c is a self-monitoring analysis and reporting technology (S.M.A.R.T.) log area start LBA, and is provided for dividing the storage capacity 104b and the storage capacity 104d which will be described later. The details will be described later.

The storage capacity 104d is a Vender Native Capacity, and a maximum storage capacity given as a user use area. The storage capacity 104d is given by an initial identify Device data of an ATM special command. The storage capacity 104d is determined by the Vender at a design stage of the SSD 10 based on the International Disk Drive Equipment and Memory association (IDEMA) standard, and is expressed by the following Equation 1:

LBA=97,696,368+(1,953,504×((Capacity in GB)−50) Equation 1

The storage capacity 104e is an original equipment manufacture (OEM) Native Capacity, and is the storage capacity determined at the time of manufacturing in response to a request from the OEM. The storage capacity 104e is given by writing unique information of an ATM specific command. The storage capacity 104e is a value returned by a Device Configuration Identify command when a Device Configuration Overlay Feature Set is supported.

The storage capacity 104f is a Native Capacity, and its initial value is the same value as the storage capacity 104e. The storage capacity 104f is a value which can be changed by a Device Configuration Set command when a Feature Set is supported. Further, the storage capacity 104f is a value returned by a Read Native Max Address (EXT) command.

The storage capacity 104g is a Current Capacity, and is the storage capacity during use by the user. The initial value of the storage capacity 104g is the same value as the storage capacity 104f. The storage capacity 104g can be changed by a Set Max Address command. The value is returned by Word 61:60 and Word 103:100 of an Identify Device command.

The storage areas of the SSD 10 exist between adjacent ones of the storage capacities 104a-104g.

In a storage area between the storage capacities 104a and 104b, a management data (management information) 107a for operating the SSD 10 and a logical/physical table 108a for converting a logical address of data converted from the LBA into physical addresses corresponding to a sector which is a storage unit of the NAND memories 104A-104H are stored. The management data 107a and the logical/physical table 108a are data which cannot be accessed by using the LBA as a key, and is recorded, by using a fixed access path, in a fixed area in the NAND memories 104A-104H.

In a storage area between the storage capacities 104b and 104c, S.M.A.R.T. log data 107b which is statistical information of the foregoing temperature information, for example, is stored. The S.M.A.R.T. log data 107b is accessed by using the LBA as a key in being recorded an inside of firmware, and is not be accessed by an ordinary Read command or a Write command from the host apparatus 8.

In a storage area between the storage capacities 104c and 104d, a non-used storage area having a storage capacity of 2 MB is set, for example. This is in order to handle the S.M.A.R.T. log data 107b and the data recorded in the storage capacity 104d or latter independently by providing a free storage area having a storage capacity of more than 1 MB, since a minimum storage unit of actual data is naturally 1 sector while a minimum storage unit of the LBA is 8 sectors and is the storage unit corresponding to 4 KB (a large storage unit is 1 MB).

A storage area between the storage capacities 104d and 104e is unused and both the storage capacities have the same value except in special cases.

A storage area between the storage capacities 104e and 104f is a storage area used by the OEM, and the unique information 107e determined by a request from the OEM is written as mentioned above.

A storage area between the storage capacities 104f and 104g is the storage area used by the OEM or user, and data is written therein by setting by the OEM or user.

A storage area of the storage capacity 104g is a storage area used by the user, and data is written therein by setting by the user.

A storage capacities 104a-104g satisfy the relationship expressed by the following Equation 2:

Storage capacity 104a>storage capacity 104b>storage capacity 104c>storage capacity 104d>=storage capacity 104e>=storage capacity 104f storage capacity 104g Equation 2

At the time of shipping from a vender, the storage capacities 104d-104g are the same values.

(Configuration of NAND Memory)

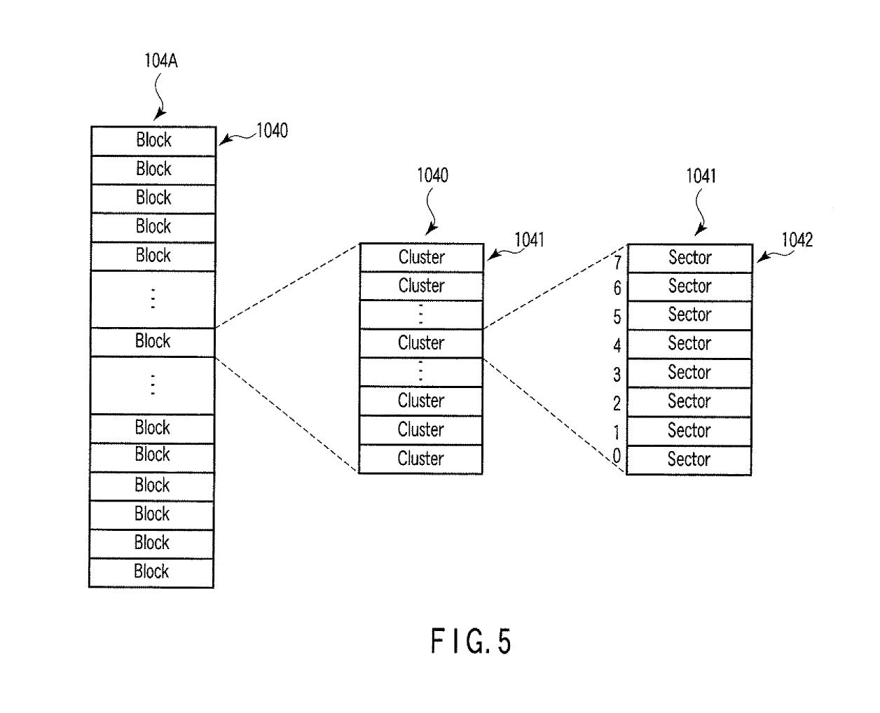

FIG. 5 shows a schematic configuration of a NAND memory according to the embodiment of the invention. Since the NAND memories 104A-104H each have the same function and configuration, an explanation will be made only about the NAND memory 104A. As one example, it is assumed that numbers 0-7 at the left of a sector 1042 indicate sector numbers.

The NAND memory 104A is composed of a plurality of blocks 1040. Each of the blocks 1040 is composed of 1024 clusters 1041, and each of the cluster 1041 is further composed of 8 sectors 1042.

(Operation)

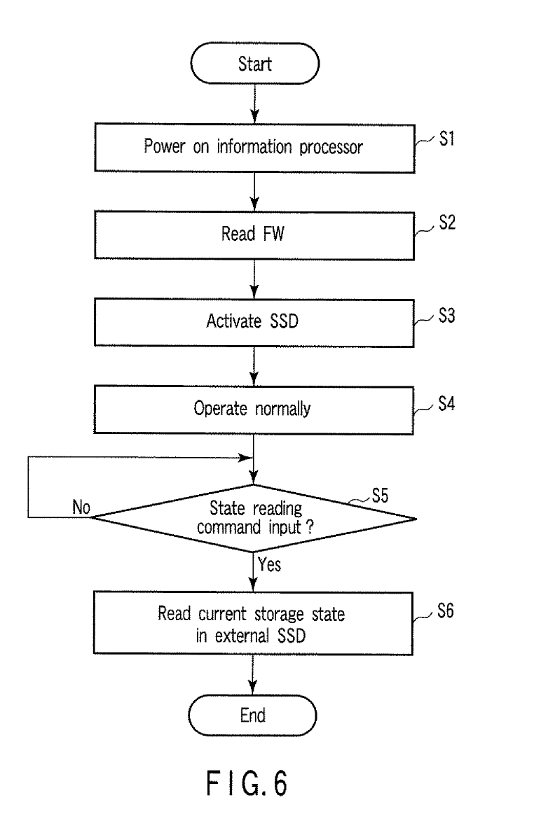

FIG. 6 is an exemplary flowchart showing a first operation of the information processing apparatus 1 of the embodiment of the invention. The first operation stores an environment before a defect occurs in a state in which the SSD 10 operates. The first operation of the processor will be described hereinafter while referring to FIG. 1, FIG. 2, FIG. 3, FIG. 4 and FIG. 5.

At first, when the user operates a power switch 25 of the information processing apparatus 1 to turn on the power supply (S1), the south bridge 113 gives an instruction to activate the SSD 10 then a temperature sensor 101, a control unit 103, NAND memories 104A-104H, and a DRAM 105 are powered on. Next, a boot loader included in management data 107a of the SSD 10 reads firmware (FW) stored in the NAND memories 104A-104H in the DRAM 105 to load the firmware (S2). The firmware loaded in the DRAM 105 further reads storage states stored in the NAND memories 104A-104H. Thereby, the SSD 10 is activated (S3) and performs a normal operation (S4).

In operating the normal operation of the SSD 10, before performing, for example, an operation which surely causes a serious error so as to disapprove reading, an environment storage recovering module 103A of the control unit 103 outputs a state reading command for current storage states in the NAND memories 104A-104H (Yes in S5). The control unit 103 reads the entire of the current storage states of the NAND memories 104A-104H on the basis of the state reading command, and stores the storage states in an external large-capacity storage device, etc., connected to a USB terminal 11 via a USB bus from the south bridge 113 that is a host apparatus 8 (S6). The connection of the large-capacity storage device, etc., disposed outside the information processing apparatus 1 may be performed in a connection method other than USB connection. The read storage states may be stored in a storage medium such as a large-capacity memory card inserted into a card slot 28.

The aforementioned SSD 10 performs wear leveling so as to average the number of times of writing and erasing the NAND memories 104A-104H when the power is turned on, thereby the states of the NAND memories 104A-104H are sequentially varied. Therefore, storing the environment in the current operation before the defect occurs prevents eliminating the environment which causes the defect due to the wear leveling, and makes it possible to perform a failure analysis later.

However, according to an aspect of the operation of the SSD 10, since the storage states of the NAND memories 104A-104H vary sequentially, only by writing to recover the storage content stored externally in the NAND memories 104A-104H, the storage states of the NAND memories 104A-104H immediately vary to make it impossible to analyze for breaking down the cause of the defect as operates after writing. Therefore, a second operation for reproducing an environment before the occurrence of the defect will be described on the basis of the store environment.

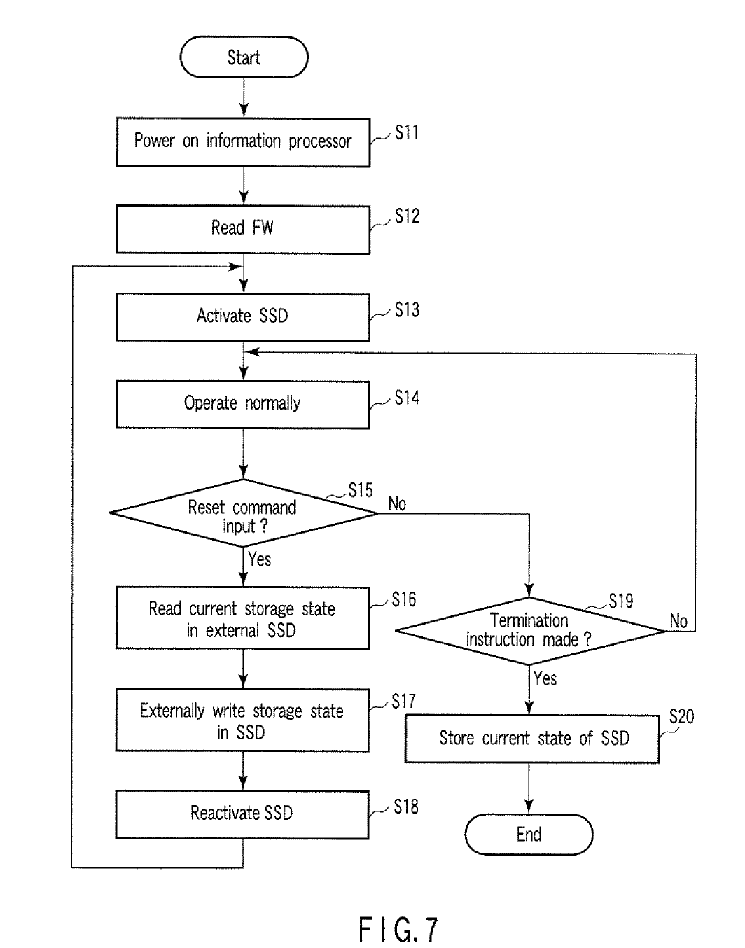

FIG. 7 is an exemplary flowchart showing the second operation of the information processing apparatus 1 of the invention. The second operation exteriorly stores the environment once before the defect occurs in a state of an operation of the SSD 10, and quickly reactivates the SSD 10 after writing the environment.

In FIG. 7, since Blocks S11-S14 are the same as Blocks S1-S4 which have been described at the first operation shown in FIG. 6, overlapping descriptions will be omitted, and Block S15 or later will be described.

In the second operation, in operating the normal operation of the SSD 10, before performing, for example, the operation which surely causes a serious error so as to disapprove reading, the environment storage recovering module 103A of the control unit 103 outputs a reset command for current storage states in the NAND memories 104A-104H (Yes in S15). The control unit 103 reads the entire of the current storage states of the NAND memories 104A-104H on the basis of the reset command, and stores the storage states in the external large-capacity storage device, etc., connected to the USB terminal 11 via the USB bus from the south bridge 113 that is the host apparatus 8 (S16). Here, “reset” means an operation which reads the storage states of the NAND memories 104A-104H before present differing from the storage state of the current NAND memories 104A-104H from the external large-capacity storage device, etc., to write the storage states in the SSD 10, and reactivates the SSD 10 without passing through a normal termination procedure. Timing for outputting the reset command is, for example, a time point that satisfies a predetermined condition given from a manufacturer.

Next, the environment storage recovering module 103A reads the storage states of the NAND memories 104A-104H stored in the large-capacity storage device connected to the USB terminal 11 of the information processing apparatus 1 via the south bridge 113, and writes the storage state in the SSD 10 again (S17). After the writing, the control unit 103 stores the storage states which have been written in the SSD 10, and reactivates the SSD 10 so that the wear leveling is not carried out (S18).

In this way, reactivating the SSD 10 loads the former storage states of the NAND memories 104A-104H, which have been externally written, into the NAND memories 104A-104H. The storage states to be externally written in the NAND memories 104A-104H of the SSD 10 on the basis of the reset command may be selected from a plurality of storage states stored in the large-capacity storage device, etc. When it is predicted that the serious error will occur in the SSD 10, it may be preset which of the first operation and the second operation should be performed for verifying the occurrence of the error.

If the reset command has not been input in normal operation (No in S15), and for example, when the termination instruction for the information processing apparatus 1 (e.g., standby command) is issued though the input operation from the keyboard 23a by the user (S19), the control unit 103 stores the storage states of the current NAND memories 104A-104H (S20).

As mentioned above, writing the former storage states which have been exteriorly stored in the NAND memories 104A-104H of the SSD 10 and reactivating the SSD 10 through a procedure differing from the normal termination procedure enables reproducing the former storage states in the NAND memories 104A-104H if necessary, it becomes able to verify the defect analysis, etc., on the basis of the reproduction.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

What is claimed is:

1. An information processing apparatus comprising:
an information processing apparatus main body; and
a non-volatile semiconductor memory drive which is accommodated in the information processing apparatus main body,
the information processing apparatus main body including:
a reload module configured to recover a storage state at a predetermined time point of the non-volatile semiconductor memory drive into the non-volatile semiconductor memory drive; and
a forcibly reset module configured to reactivate the non-volatile semiconductor memory drive in a state of storing the storage state recovered by the reload module,
the non-volatile semiconductor memory drive including:
the non-volatile semiconductor memory which includes a plurality of storage areas where information is writable and information is readable; and
a memory control module configured to write the storage state at the predetermined time point input from the information processing apparatus main body into the non-volatile semiconductor memory, and to reactivate the non-volatile semiconductor memory drive in a state where the written storage state is stored in the non-volatile semiconductor memory.

2. The information processing apparatus of claim 1, wherein the memory control module of the non-volatile semiconductor memory drive does not store a state of the non-volatile semiconductor memory drive when reactivates the nonvolatile semiconductor memory drive according to an instruction from the forcibly reset module of the information processing apparatus main body.

3. The information processing apparatus of claim 1, wherein the non-volatile semiconductor memory drive further includes a wear leveling function of averaging the number of times of writing deletion, and the memory control module invalidates the wear leveling function when reactivates the of the non-volatile semiconductor memory drive according to an instruction from the forcibly reset module of the information processing apparatus main body.

4. A non-volatile semiconductor memory drive which is accommodated in the information processing apparatus main body, comprising:
a non-volatile semiconductor memory which includes a plurality of storage areas where information is writable and information is readable; and
a memory control module configured to write a storage state at a prescribed time point in the non-volatile semiconductor memory drive input from the information processing apparatus main body into the non-volatile semiconductor memory, and to reactivate the non-volatile semiconductor memory drive in a state where the written storage state is stored in the non-volatile semiconductor memory.

5. The non-volatile semiconductor memory drive of claim 4, wherein the memory control module does not store a state of the non-volatile semiconductor memory drive when reactivates the non-volatile semiconductor memory drive according to a forcibly reset instruction from the information processing apparatus main body.

6. The non-volatile semiconductor memory drive of claim 4, further comprising a wear leveling function of averaging the number of times of writing and erasing, wherein:
the memory control module invalidates the fatigue leveling function when reactivates the non-volatile semiconductor memory drive according to the forcibly reset instruction from the information processing apparatus main unit.
